(19) United States
(12) Patent Application Publication
(10) Pub. No.: US 2005/0265240 A1
(43) Pub. Date: Dec. 1, 2005

(54) Broadband network and application service testing method and apparatus

(75) Inventors: Sanjay Jain, Chappaqua, NY (US); Hamid Modarressi, Greenwich, CT (US); William Dorsey, West Hartford, CT (US)

Correspondence Address: Jeffery J. Brosemer, Ph.D., ESQ., 138 S. Telegraph Hill Road, Holmdel, NJ, 07733, US

(73) Assignee: DataLinx Corporation, Tarrytown, NY (US)

(21) Appl. No.: 10/839,044

(22) Filed: May 5, 2004

(51) Int. Cl. H04L 12/28

(52) U.S. Cl. 370/241

(57) ABSTRACT

A method and system for testing broadband networks and broadband applications. The system performs customer-centric, subscriber-initiated broadband network and broadband application service testing by validating network setup and gateway configuration for broadband application(s); characterizing application service performance; and identifying faults while recommending remedial actions. The method and system optionally pushes fault information and diagnostic test results to service provider(s).

### FIELD OF THE INVENTION

This invention relates generally to the field of telecommunications and in particular to broadband network and application service testing. More specifically, our invention facilitates the testing/diagnosis of broadband applications by a broadband application customer or broadband service provider.

### BACKGROUND OF THE INVENTION

Broadband—high speed, always-on Internet connectivity—represents the next phase in the evolution of the Internet. In fact, experts predict broadband will enable applications and services that transform our economy, education, health-care, Research and Development, entertainment, homeland security, military effectiveness and quality of life. The continued deployment and usage of broadband and broadband applications and services will therefore significantly impact future broadband customers of all types, be they individual consumers or businesses.

With such extraordinary possibilities, robust broadband demand and usage seems inevitable. Despite this tremendous potential however, there are a number of factors that negatively impact the robustness of the demand. In particular, for consumers and businesses alike, disappointment with the quality and or reliability of service, coupled with frustration caused by difficult provisioning, installation, diagnosis, repair, or service, may seriously limit or delay broadband adoption.

The magnitude and difficulty of the problem is understood by first noting that much of the attractiveness of broadband is derived from the rich array of “in-demand” applications such as: streaming media including Internet radio, peer-to-peer or multiplayer game playing, video-on-demand, and telephony including voice-over-IP (VoIP) and video phone/conferencing. Deploying and delivering these services requires a complex combination of multiple technologies, systems, and commercial organizational entities including access service providers, Internet service providers and broadband application service providers.

Consequently, there is developing in the broadband environment an almost infinite number of combinations of hardware, operating systems, installed applications software, telecommunications facilities, and interconnected and/or related devices. When this is further combined with the varied access services/providers and Internet services/providers and application service providers available, it results in a customer service nightmare in diagnosing problems, let alone solving them. In the broadband-connected home for example, customer service expertise must now include computing equipment, networking equipment, telecommunications equipment, systems software, applications software, consumer electronics, and—down the road—intelligent consumer appliances.

Unfortunately however, broadband service quality and application service quality is typically viewed from the perspective of the service provider network and, as a result, service diagnosis and test tools take a “network-centric” approach without regard to, or ignorant of, the complex premises configuration(s) that are becoming common. As a result, this network-centric approach falls far short of solving the testing needs of today's broadband network environment(s), and will likely become increasingly deficient in the future.

Accordingly, a continuing need exists for systems and methods that further facilitate the diagnosis, test, troubleshooting and repair of necessarily complex broadband services and systems.

### SUMMARY OF THE INVENTION

In recognition of this deficiency in the Art, we have developed a suite of diagnostic tools—including methods and systems which we have named Push2Test (P2T)—that assist broadband customers, broadband service providers, and broadband application service providers, in provisioning, diagnosing, testing, troubleshooting, repairing and maintaining broadband systems and broadband applications.

In sharp contrast to the network-centric approach of the prior art, our inventive P2T takes a consumer or “customer-centric” approach in which testing takes place starting on the premises—with knowledge of the customer premises environment —and expands outward through the broadband service provider network and on to the broadband application service provider network(s). Advantageously our inventive P2T operates in both individual consumer (residential) and business broadband environments.

According to an aspect of our invention, and unlike common telecommunications testing initiated by a service provider such as a Regional Bell Operating Company (RBOC), a broadband customer initiates a test/test suite to be performed (on-demand testing). This testing originates at the customer premises from a Push-2-Test client and propagates outward into an access network and further into an application service provider network where it optionally interacts with specific Push-2-Test server(s). The initiated test/suite dictates a set of atomic tests to be performed, and in what particular sequence. The performed atomic tests are then interpreted by a rule-based expert system and the interpreted results are presented to the broadband customer.

Advantageously, the reported results may be presented in a readily-recognizable manner using, for example, colors such as red, yellow, and green indicative of problems, potential problems, or no problems respectively. In addition, an expert discussion on the results may be presented to the broadband customer, describing in detail the presented test results.

Of further advantage, an expert prescription may be provided, so that automatic adjustments and/or fixes can be performed in an attempt to remedy the diagnosed problem(s).

A further aspect of our invention provides data and/or information specific to a local customer network—data that may be indicative of service incompatibilities and which was up-to-now unavailable to access and service providers—such that service provisioning is enhanced and further facilitated, for both customer and access and/or application service provider.

Yet another aspect of our invention is its ability to examine a broadband environment under test across a spectrum of possible broadband application services, thereby determining/reporting particular service needs based on service requirements.

Further features and advantages will become apparent with reference to the accompanying drawing and illustrative detailed description.

### BRIEF DESCRIPTION OF THE DRAWING

FIG. 1 is an architectural block diagram depicting an illustrative broadband network including representative broadband services, according to the present invention;

FIG. 2 is an architectural block diagram depicting an illustrative Push-2-Test client (P2T_{c}) software architecture according to the present invention;

FIG. 3 is a block diagram showing the relationship between user interface, rules engine, test sequencer, and tests according to the present invention; and

FIG. 4 is a block diagram showing operationally, a representative testing according to the present invention.

### DETAILED DESCRIPTION

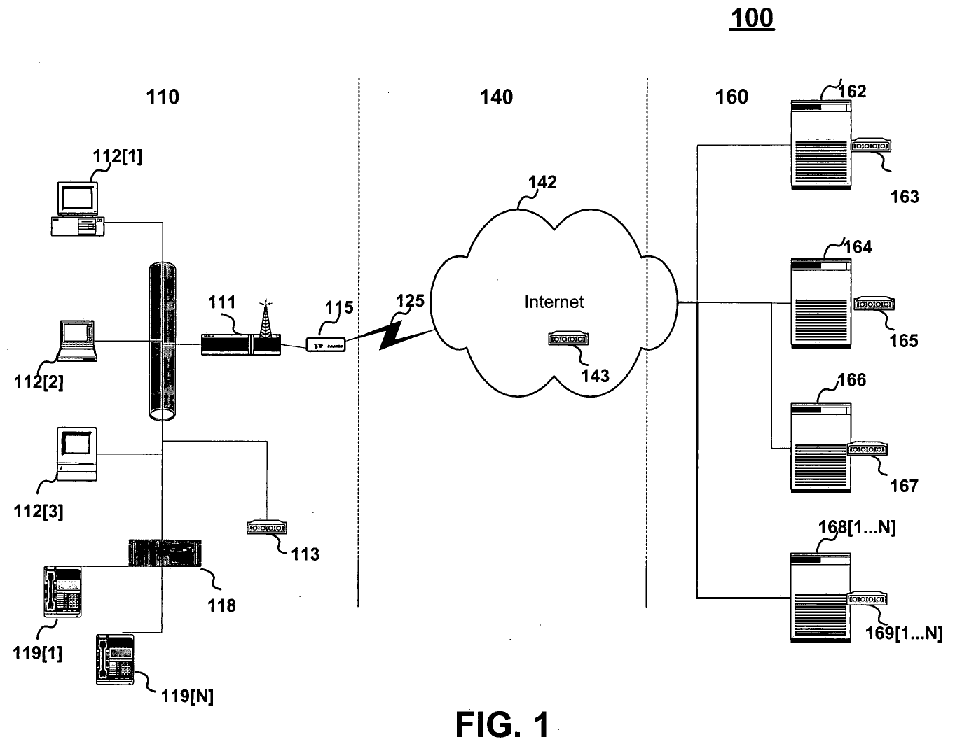

Illustrative examples of our invention will now be presented with reference to the attached drawing. Referring to FIG. 1, there is shown an architectural block diagram that depicts a broadband network including representative broadband services according to our inventive teaching. Specifically, shown therein is a broadband network 100 that is further divided into three broad sections namely, a home network 110, an access network 140 and a service provider network 160.

For the purposes of this discussion and to further spotlight advantageous aspects of our invention, the home network 110 is shown in FIG. 1 having a modest complexity. Importantly, our invention works in home environments covering a range of complexities, from a simple, single personal computer to those involving a number of networked elements or systems. Interestingly, our invention may show its greatest value in complex environments in which testing, diagnosis, maintenance and repair is most difficult. Of further importance—and what will be readily apparent to those skilled in the art—is the observation that while we have shown a representative home network 110, in FIG. 1, we could have equally well shown a business network for the purpose(s) of our discussion.

As shown in FIG. 1, the home network 110 is interconnected to access network 140 through access device 115 via access facility(ies) 125. Advantageously, the interconnect between the home network 110 and the access network 140 is variable, as a number of access configurations are possible and accommodated by our invention.

In particular, the access device 115 may be a cable modem utilizing cable television facilities as access facility 125. Alternatively, access device 115 may be a DSL modem, operating via existing copper media as access facility 125. Both of these options are becoming increasingly available and affordable, leading to their ready adoption.

At this point, it is useful to note that our invention is not limited to these two, commonly available access options. More specifically, it is expected that a number of technologies are either available or emerging that hold promise for broadband access and therefore use with our invention. Direct satellite, for example, is already available in a number of geographic locations, and in such a configuration the access device 115 would be a satellite interface unit. Looking forward, optical fiber to the home (FTTH), broadband wireless, broadband Integrated Services Digital Network (B-ISDN), fixed wireless, and even free-space optical networking may offer desirable customer access. In such environments, the access device 115 would be accordingly matched to the type of access facility 125 being used. Simply stated, the particular access device 115 that is employed, provides connectivity between the home network 110 and the access network 140 and further to the Internet 142, via an appropriately matched access facility 125.

Returning our attention now to FIG. 1, the home network 110 environment may include one or more personal computers 112[1 . . . 3] which are shown connected to gateway 111 via wired i.e., Ethernet, UTP, USB, etc., or wireless i.e., 802.11x technologies. Also shown connected to the gateway 111 is internet protocol telephone interface 118 (VoIP gateway), which provides connectivity from internet protocol telephone(s) 119[1 . . . N] to home network out to the Internet 142, thereby enabling voice-over-IP applications (VoIP).

As can be appreciated, the gateway 111 (which for our purposes may be called home router, or home gateway or residential gateway) is an intelligent network interface device located on the customer premises which, as we noted before, could be either a home network or a business network equally well.

Continuing in our discussion, gateway 111 provides the means for the customer to access the Internet 142 and its services, as well as different devices located within the home network 110. Common, commercially available gateways may perform the bridging/routing, protocol and address translation between an external broadband network and an internal home network having a number and variety of networked devices. It may operate as a secure firewall—defending the home network 110 from outside intruders—while serving as the focal point for applications. Gateway devices may even allow users to access a home network 110 and control various networked devices from a remote location via the Internet 142. Some gateways even include access device 115 characteristics, (such as a cable modem) thereby eliminating the need for an additional physical device. Advantageously, our inventive teachings apply to such variations as well.

Completing our discussion of the home network 110, we note the presence of our inventive Push-2-Test client (P2S_{c}), which advantageously may be located in any of the devices described previously, i.e., personal computers 112[1 . . . 3], gateway 111, IP Telephony interface 118, in a stand alone P2T_{c} device 113 or others (not specifically shown). In operation (which will be discussed in detail later), the P2T_{c} software system works in conjunction with Push-2-Test server (P2Tₛ) systems located external to the home network, i.e., in the access network 140, or service provider network(s) 160 to test the broadband network and applications.

With further reference to FIG. 1, access network 140 is interconnected with the home network 110 via access facility(ies) 125 and to Internet 142. As can be appreciated, precisely defining the Internet 142 and in particular depicting it in a figure such as FIG. 1 is rather imprecise. More specifically, and as used throughout this specification, it is understood that the Internet 142 is a collection of interconnected networks some of which may provide further services/features accessed and or utilized by a customer.

As such, service provider network 160 is shown in FIG. 1 as being connected to Internet 140, is comprised of an array of individual services. Shown in FIG. 1, are familiar emerging broadband services such as streaming media service(s) 162, Voice-over-IP (VoIP) services 164, gaming services 166, and others 168[1 . . . N]. Shown associated with each of these services, is a corresponding Push-2-Test server (P2Tₛ), 163, 165, 167, and 169[1 . . . N] for each of the services shown, streaming media service(s) 162, Voice-over-IP services 164, gaming services 166, and others 168[1 . . . N], respectively. Each or any of these Push-2-Test servers, as well as any others situated within the access network 140, such as P2Tₛ 143, will interact with individual Push-2-Test client(s) to test and diagnose the broadband network and applications.

Of particular importance, the combined capability of the Push-2-Test clients with the Push-2-Test server(s) may produce a significant improvement in customer service experience for consumers of broadband services, while lowering operational costs for service providers. More specifically, customers will be able to perform tests and diagnostics independently from access providers, while providing the service providers with invaluable test and diagnostic results as perceived from the perspective of the home network 110.

This is due, in part, to the fact that service providers today typically have no “visibility” into home networks, such as home network 110. Push-2-Test overcomes this “blindness” by providing and coordinating real-time statistics and characteristics of the home network 110 with those of the particular service and/or service provider, as required or desired.

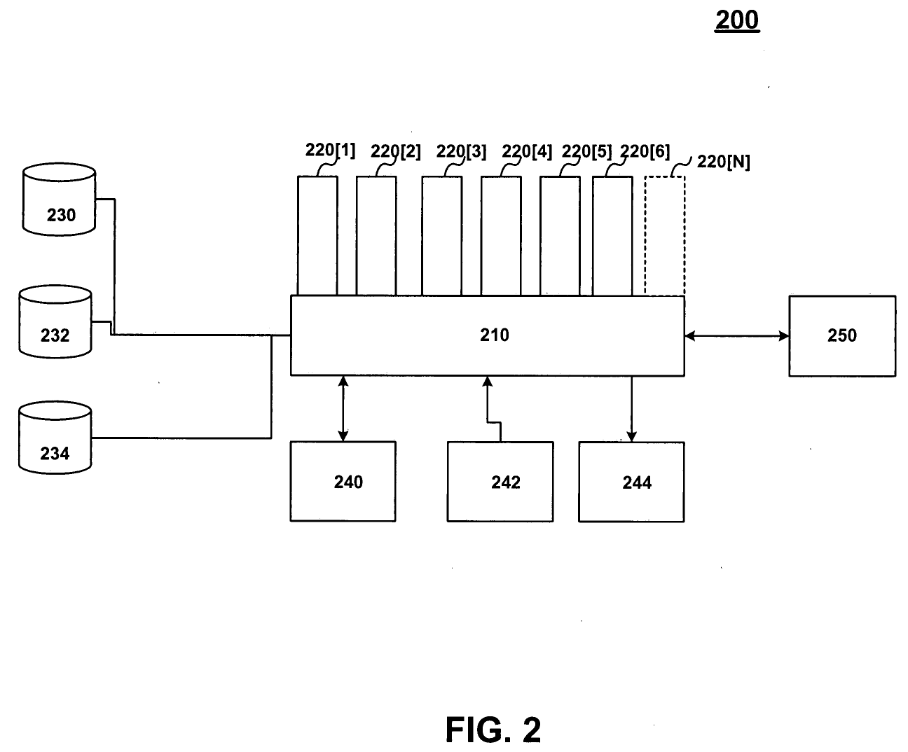

Turning our attention now to FIG. 2, there is shown an architectural block diagram of a representative Push-2-Test client (P2T_{c}) software architecture 200. In particular, client architecture 200 includes a diagnostic engine 210 that interacts with and coordinates the use of specific diagnostic modules 220[1 . . . N]. Advantageously, and as should be readily appreciated by those skilled in the art, the specific diagnostic modules used in a particular client will depend upon that client's broadband environment. As such, diagnostic modules may be distributed and/or deployed separately and “plugged-into” (or “unplugged from”) existing or new systems as appropriate and/or desired.

In operation, a user of the system may interact with the diagnostic engine 210 through graphical user interface 250. As can be readily appreciated by those skilled in the art, graphical user interfaces (GUIs) are well known in the Art and a general discussion of same is beyond the scope of this description. Examples of such GUIs which work well with our invention include: MS-Windows (98,2000,XP, etc), Apple Macintosh, as well as the variety of GUIs available for Unix/Linux variants. And while the specific graphical user interface used is not particularly important, it should be noted that whatever interface is used should be at least: 1) clear, concise, and sufficiently “non-technical” for a user; 2) intuitive in its operation; and 3) able to provide items of informational value to a user, i.e., reports or alarms, with distinguishing characteristics such as color/cursor attributes/audible or other visual cues.

Other components of the client architecture 200 include a CMD Generator and Interpreter 240, network sniffer 242, network traffic generator 244 and a set of configuration/environmental databases including a broadband services configuration database 230, a packet signature and help database, and a home network and gateway database 234.

The broadband services adaptor 230 contains broadband services specific data characterizing the broadband services that may be tested by the specific Push-2-Test client. In particular, the broadband services adaptor 230 contains data such as service provider specific configuration and performance parameters including throughput, latencies as well as historical data on specific services. Similarly, the home network and gateway adaptors 234 contains that data specific to the characteristics of the particular home network and gateway which may also include historical data of the home network. Lastly, the packet signature and help adaptor 232 contains the rules engine data, which is used to intelligently evaluate test results for diagnosis and presentation to a user.

Diagnostic modules 220[1 . . . N] operate to provide specific tests and/or diagnostics for particular aspects of the broadband network. Specifically, the home network and gateway module 220[1] performs at least the following functions: 1) Validating home gateway configuration; 2) determining attached network devices; and 3) analyzing home network traffic analysis.

When validating the home gateway configuration, the home network and gateway module 220[1] checks and/or modifies the home gateway settings such that they conform to a specific, selected broadband service provider requirements.

In determining attached network devices, the home network gateway configuration module 220[1] will: 1) determine attached network devices such as: desktops, laptops, network printers, VoIP gateway(s), Internet gaming consoles, etc.; 2) graphically display the determined network devices for view by a user; 3) validate communication with each of the attached devices through one of a variety of methods such as the well-known “PING”; and 4) graphically display relative communication “health” of the attached devices. In this manner, a user of the system will readily recognize when communications problems are present.

Home network traffic analysis is performed by the home network and gateway module 220[1] by: 1) generating and displaying network device/application/bandwidth utilization table(s); and 2) identifying potential problem areas such as: excess broadcast traffic, virus related traffic; or unused protocol traffic.

The broadband module 220[2] of FIG. 2, provides specific testing and/or diagnostics of the broadband access. Specifically, the broadband module 220[2] will validate the home gateway setup for particular broadband access service(s) by examining characteristic settings such as: Dynamic Host Configuration Protocol (DHCP) and Network Address Translation (NAT); firewall settings; content filter settings; and router settings including port forwarding and static routing assignments.

Additionally, broadband module 220[2] will validate the broadband access performance of a service provider network by communicating with an access network Push-2-Test server such as that depicted by reference numeral 143 of FIG. 1. Specific measurements of broadband access performance may include, but not limited to: domain name service(s) (DNS) delay; “real” throughput measurements; and latency.

Lastly, broadband module 220[2] will monitor/diagnose uniform resource locator (URL) performance by: 1) receiving a user specified URL to monitor; 2) monitoring the performance metrics to the specified URL and; 3) diagnosing the performance and identifies the source of any bottlenecks.

The VoIP module 220[3] performs both local, home area network (HAN) testing of the home network, and end-to-end testing of VoIP services in conjunction with VoIP Push-2-Test server such as that depicted by reference numeral 165 in FIG. 1.

In testing the HAN, VoIP module 220[3] validates home gateway setup for VoIP application(s). In particular, the home gateway validation for VoIP applications includes: DHCP and NAT settings; firewall settings; content filter settings; and router settings such as port forwarding, static routing and Universal Plug and Play (UpnP) characteristics.

In addition to validating the home gateway setup for VoIP applications, the VoIP module 220[3] will validate any VoIP adaptor settings if such device data is present and available. Specific settings include network settings such as DHCP, NAT and DNS; and VoIP Protocol settings including the characteristics of any proxy(ies); media ports and audio compression settings.

Lastly, the VoIP module 220[3] performs error checking by reading/analyzing any error related data such as log entries from the home gateway and VoIP adaptor and subsequently analyzes that data for potential VoIP related problems.

Advantageously, the VoIP testing is not limited to HAN components. By interacting with VoIP Push-2-Test server 165, end-to-end service performance is determined. In particular, end-to-end testing includes call setup/call control functions such as: server discovery delay; registration and admission/proxy authentication delay; post-dial delay (PDD); post-pickup delay (PPD); call completion and signaling message transaction history. Setup/control protocols tested include the familiar H.323; Session Initiation Protocol (SIP); Skinny Client Control Protocol (SCCP); Media Gateway Control Protocol (MGCP); and PacketCable Network-based Call Signaling (NCS) protocols.

In addition to the setup/control functions, characteristics affecting perceived VoIP call quality are determined by the VoIP test module 220[3]. Specifically, standardized call quality measurement(s) such as that based on ITU-T G.107 are performed as well as other measured characteristics that affect the perceived call quality are determined. In particular, measurements of latency including one-way as well as round-trip are determined along with statistical analysis of same including average trip times, median trip times, relative standard deviation and min/max.

Additional end-to-end measurements performed VoIP test module 220[3] include jitter (both directions, and its distribution(s)); and packet loss including: loss totals, consecutive bursts; as well as early/late/out of sequence packets. Lastly, the end-to-end call quality characteristics are evaluated across a variety of coding schemes including G.711, G.722, G.723.1, G.726, G.728, G.729, G.729A, G.729B, and G.729AB. Of course, those skilled in the art will appreciate that our invention permits/accommodates variations in the above-described testing as standards/technologies evolve and/or change. As such, new standards and/or protocols may be readily implemented by our Push-2-Test system.

A particular advantage to our inventive Push-2-Test client system is its ability to accommodate future broadband applications testing such as the future gaming module 220[4], future video module 220[5] and future custom modules 220[6], through and including yet undefined broadband application modules 220[N]. These test modules will interact with corresponding Push-2-Test server such as the video game service and respective video game Push-2-Test server shown in FIG. 1 as reference 166 and 167, respectively. Similarly, other, undefined applications/servers which may be defined in the future are represented by 168 and 169 in FIG. 1.

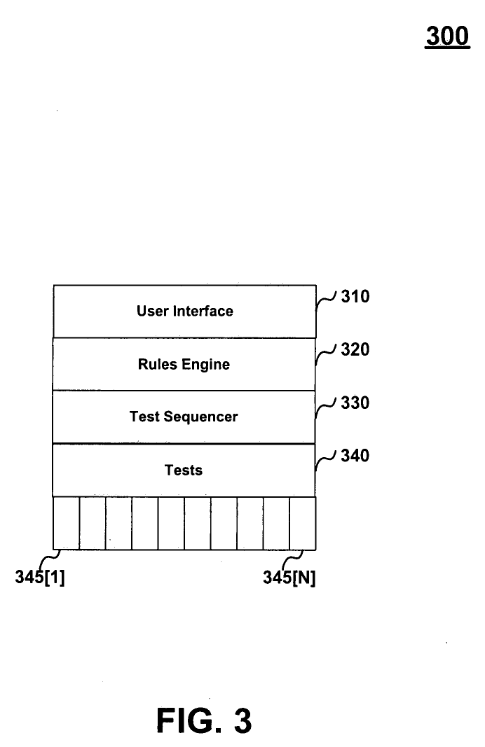

With reference now to FIG. 3, there is shown a block diagram depicting the logical relationships among functions comprising our inventive Push-2-Test system and is useful in understanding its operation. In particular, a user of the Push-2-Test system initiates testing (typically from the customer premises) through the system user interface system, 310 by specifying one or more tests to be performed.

In response to the user-initiated specific testing request, test sequencer module 330 determines which particular atomic tests 345[1] . . . 345[N] from test set 340 are to be used in the testing and in what order (sequence). As can be appreciated, atomic tests do not commute, that is, they are order dependent. For example, if a user initiated a throughput test, the system must first determine connectivity prior to determining throughput. Consequently, in this example, atomic tests would be sequenced such that connectivity is determined first, and then throughput is determined subsequently. Of further importance, additional atomic tests and/or rules may be added to the test set 340 or rules engine 320, respectively, as the broadband environment chages.

Finally rules engine 320, interprets the specific sequenced test results and based upon rules and thresholds, interprets the results.

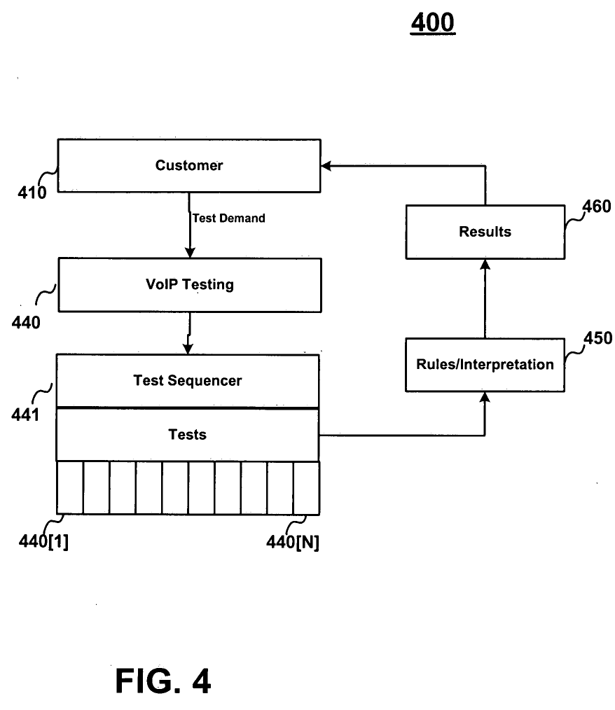

The operational flow of this set of functions is shown in FIG. 4. Specifically, a customer initiates a demand or set of demands for tests 420. In this example, the testing involves VoIP testing 430, which defines a set of atomic tests 440 performed in a particular sequence 441. Raw test results are interpreted by rules 450 and the interpreted results 460 are presented to the customer, who may optionally, initiate another demand or refined demand for further testing.

As noted prior, but not specifically shown in this figure, interpreted test results 460 may be presented to the user in a color-coded report format in which, for example, a red color indicates an issue/problem; a yellow color indicative of a potential issue/problem; and a green color indicative of no issue/problem detected. Along with this report, an expert discussion on the results may be also provided along with one or more recommendations for further action, as appropriate.

Of course, it will be understood by those skilled in the art that the foregoing is merely illustrative of the principles of this invention, and that various modifications can be made by those skilled in the art without departing from the scope and spirit of the invention. Accordingly, my invention is to be limited only by the scope of the claims attached hereto.

1. A method of testing a broadband network comprising the steps of:
testing certain broadband characteristics of a home area network;
testing, certain broadband characteristics of a broadband access provider network; and
testing, certain broadband characteristics of a broadband application service provider network and overriding broadband application service(s);
wherein each of the above testing is initiated by a subscriber to the broadband application service(s) from the subscriber premises.

2. The method according to claim 1 wherein the home area network testing further comprising the step of:
validating, a home gateway configuration by checking and/or modifying home gateway settings such that they conform to selected broadband service provider requirements.

3. The method according to claim 2 wherein the home area network testing further comprises the steps of:
determining, devices attached to the home area network;
displaying, on a user interface device, devices determined to be attached to the home area network;
evaluating communication characteristics of each of the devices determined to be attached to the home area network; and
displaying, on the user interface device, graphical representations of the evaluated communication characteristics.

4. The method according to claim 3 wherein the home area network testing further comprises steps of:
generating a device/application/bandwidth utilization table; and
analyzing, home area network traffic for potential problems.

5. The method according to claim 1 wherein the broadband access provider network testing further comprises the steps of:
determining, whether a home gateway configuration settings suitably match required settings for the broadband access provider network;
determining, whether the home gateway received an appropriate Internet Protocol address from the broadband access provider;
checking, any applicable firewall setting(s);
checking, and applicable router settings; and
testing performance characteristics of the broadband access provider network by interacting with a server resident in the broadband access provider network.

6. The method according to claim 1 wherein the broadband application service provider network and overriding broadband application service(s) testing further comprises the steps of:
determining, whether a home gateway configuration settings suitably match required settings for the broadband application service provider network; and
testing performance characteristics of the broadband application service provider network by interacting with a server resident in the broadband service provider network.

7. The method according to claim 1 the overriding broadband application service is a Voice-Over-IP (VoIP) application service and the broadband application service provider network and overriding broadband application service(s) testing further comprises the steps of:
determining, whether a home gateway configuration settings suitably match required settings for the broadband application service provider network;
determining, whether a VoIP gateway settings, resident in the home network, suitably match required setting(s) for the VoIP service provider;
determining, whether the VoIP gateway registers any errors; and
testing performance characteristics of the broadband application service provider network by interacting with a server resident in the broadband application service provider network wherein the performance characteristics include call control functions and call quality characteristics.

8. The method according to claim 7 wherein the call control functions tested include: server discovery delay, registrations and admission/proxy authentication delay, post-dial delay, post-pickup delay, call completion and signaling message transaction history.

9. The method according to claim 7 wherein the call quality characteristics tested are compliant with ITU-T G.107 call quality measurement characteristics.

10. In a broadband network comprising a broadband home area network and a broadband access service provider network, a method of evaluating the broadband network comprising the steps of:
determining, certain broadband characteristics of the home area network;
determining, certain broadband characteristics of the access service provider network; and
determining, whether a proposed broadband application service provided by a broadband application service provider and resident in a broadband network associated with that broadband application service provider is compatible with the determined characteristics of the home area network and/or the determined broadband characteristics of the access service provider network;
wherein each of the above determinations is initiated by a prospective subscriber to the broadband application service from the subscriber premises.

11. The method according to claim 10 further comprising the step of:
recommending, in the event that the proposed broadband application service is incompatible with the determined characteristics of the home area network and/or the determined broadband characteristics of the access service provider network, certain broadband characteristics of the home area network; one or more changes to the home area network and/or access service provider network
such that the proposed broadband application is sufficiently compatible with the changed home area network and/or access service provider network.

12. The method according to claim 11 further comprising the step of:
changing, one or more characteristics of the home area network and/or broadband access service provider network such that the proposed broadband application is sufficiently compatible.

13. The method according to claim 12 wherein said recommendation is generated by a rule-based expert system.

14. The method according to claim 10 wherein the broadband network further comprises an existing broadband application service provided by a broadband application service provider and said determining step further comprises the step of:
determining whether a proposed broadband application service provided by a broadband application service provider and resident in a broadband network associated with that broadband application service provider is sufficiently compatible with the existing broadband application service.

15. In a broadband network comprising a broadband home area network interconnected to a broadband access service provider network further interconnected to a broadband application service network wherein the broadband application service network includes one or more broadband application servers, a system for testing the broadband network comprising:
a client test system, resident in the home area network; the client test system including:
a home area network test module for testing the home area network;
a broadband access service provider network test module for testing the broadband access service provider network;
a broadband application service test module, for interacting with a corresponding server test system to test the broadband application, said server test system being resident in the broadband application service network; and
a diagnostic engine, in communication with each of the above test modules, said diagnostic engine for directing the operation of the above test modules and interpreting any test results derived; and
the corresponding server test system.

16. The system according to claim 15 wherein the client test system further comprises:
a rules based expert system, in communication with the diagnostic engine, for interpreting test results and/or providing expert analysis of the test(s) to a user of the system.

17. The system according to claim 16 wherein the client test system further comprises:
a sniffer, in communication with the diagnostic engine, for observing network traffic traversing the home area network.

18. The system according to claim 17 wherein the client test system further comprises:
a broadband services adaptor, in communication with the diagnostic engine, for maintaining broadband service(s) specific data characterizing the broadband application services that may be tested by the broadband application service test module.

19. The system according to claim 18 wherein the client test system further comprises:
a packet signature and help adaptor, in communication with the diagnostic engine, for maintaining data associated with the rules based expert system.

20. The system according to claim 19 wherein the client test system further comprises:
a home network and gateway adaptor, in communication with the diagnostic engine, for maintaining data specific to the characteristics of the home network and a home network gateway.
